(19) United States
(12) Patent Application Publication
(10) Pub. No.: US 2004/0253373 A1
(43) Pub. Date: Dec. 16, 2004

(54) Method of powder coating

(75) Inventor: Robert W. Langlois, Toronto (CA)

Correspondence Address: RICHES, MCKENZIE & HERBERT, LLP, SUITE 1800, 2 BLOOR STREET EAST, TORONTO, ON, M4W 3J5, CA

(73) Assignee: Alliance Surface Finishing Inc.

(21) Appl. No.: 10/805,336

(22) Filed: Mar. 22, 2004

(30) Foreign Application Priority Data
Jun. 13, 2003 (CA) 2,432,836

(51) Int. Cl. B05D 3/02

(52) U.S. Cl. 427/180; 427/421.1; 427/372.2

(57) ABSTRACT

A method of powder coating thermo powder resins to non-conductive plastic substrates, in particular, to polyamide materials and other non-conductive plastic substrates. It discloses a method for powder coating a non-conductive plastic substrate comprising the following steps:

(a) cleaning said substrates to remove any contaminants or mold release agents therefrom;

(b) applying an adhesive/sealer to said substrate;

(c) curing said adhesive/sealer by means of heat;

(d) applying a thermosetting powder to the hot substrate; and

(e) curing said thermosetting powder with heat.

### FIELD OF THE INVENTION

The present invention relates to a method of powder coating thermo powder resins to non-conductive plastic substrates, in particular, to polyamide materials (hereinafter referred to as nylon materials) and other non-conductive plastic substrates.

### BACKGROUND OF THE INVENTION

Industries such as the automotive industry are striving to look for materials that can replace existing materials to reduce costs and weight of vehicles while still maintaining quality. One such material is nylon which is a synthetic polyamide material which has characteristics unlike traditional plastics being used. Traditional plastics include polycarbonate-acrylonitrile-butadiene-styrene (hereinafter referred to as PCABS) materials which provide an electroplateable and paintable surface. Nylon as a replacement has characteristics more closely associated to metals and metal composite materials than traditional plastic materials currently being used.

At the present time, traditional materials are being wet paint applicated. However, serious environmental concerns have been raised through the use of wet paint and there are substantial costs for the equipment and paint materials to provide a suitable painted surface.

The present invention has eliminated the environmental emissions, has reduced the production costs while still providing a suitable painted surface. It finds application in the automotive, plumbing, recreational, appliance, hardware and electronics industries.

### DESCRIPTION OF THE PRIOR ART

U.S. Pat. No. 4,495,217 which issued in January, 1985 to Schrum, discloses a process using powders which require very low melting temperatures for the purposes of maintaining the integrity of the substrate. The concern is on two levels. The first concern is that it is necessary to have high cure temperatures for powders to achieve maximum performance characteristics and this is a function of temperature. The second concern is that the low melt point powders offer unwanted characteristics such as poor transportation and storage and paint application characteristics. It is possible for the low cure temperature powders to melt during transportation and storage at normal ambient temperatures. This invention utilizes high temperature cure powder configurations, thus yielding maximum performance and cost savings benefits.

Schrum proposes that the parts be done without the need for fixturing. This suggestion poses serious problems when dealing with complex three dimensional parts as it is impossible to provide full coverage of the part using Schrum's invention in one pass. It is also not possible to allow for wrap or over spray which is essential in many applications such as found in the automotive industry. Schrum also advances that his invention is only practicable on small parts. It would therefore not be feasible to use the process of Schrum for any larger part.

Schrum further states that the preferred embodiment is to use electrostatic application of powder. This has been eliminated by the present invention which is a distinct advantage.

U.S. Pat. No. 5,338,578 which issued in August, 1994 to Leach describes a process for sheet molded compounds (hereinafter referred to as SMC). This invention is intended for injected molded materials, preferably, material being made of nylon materials, which have a specific gravity greater than 1.4 which is the threshold for Leach. Leach discloses a process for achieving a high gloss finish and it is impossible to use the Leach process for matte or textured finishes. Leach also uses electrostatic powder application in its preferred embodiment.

U.S. Pat. No. 3,708,321 issued in January, 1973 to Spieles discloses a process which deposits metal flake finishes to metallic substrates. Spieles relies on a solvent-based chemical primer and Spieles relies on electrostatic spraying for a portion of the preferred embodiment.

U.S. Pat. No. 5,624,735 issued in April, 1977 to Anderson provides a process to seal the edges of SMC for the purposes of providing a smooth edge for further processing to provide a wet painted decorative surface. The application of powder materials in the Anderson invention is done by electrostatic spray.

U.S. Pat. No. 5,516,551 granted to Rhue in June, 1991 discloses a process in which the substrate temperature is maintained throughout the process above the cure temperature of the powder. Rhue discloses a process which uses degassing of the substrate which uses additional resources and energy. Rhue discloses a process which applies the powder via electrostatic spray via a conductive primer or wash or the impregnation of conductive materials in the substrate.

The process of Rhue is most normally used as a primer coat for further application by other means of a decorative finish.

U.S. Pat. No. 5,344,672 granted to Smith in September, 1994 discloses a process which relies on a conductive primer and subsequent application of powder via electrostatic spraying. This process of Smith does not allow for multiple finish coats to be applied to produce a highly uniform and reproducible class.

Fannon discloses a process in U.S. pending application 2002/0033134 which relies on UV curable powder coating materials. However, these materials are quite costly and do not provide the same performance characteristics as thermoplastic resins. This process is concerned with the proximity of IR and combustion heating equipment due to the rapid decrease in substrate temperatures and the associated safety guidelines for paint equipment. The process of Fannon relies on the application of powders via an electrostatic application. This invention is for non complex or non three dimensional parts which do not require racking or tooling. It requires the necessity of application of moisture to the substrate which leads to potential degassing and adhesion and performance characteristic issues of the finished part due to the use of moisture technique on plastic surfaces.

Fannon deals with the surface treatment of the part. It does not deal with the question of the core temperature of the part and the control of the surface temperature as the part moves between stations of the apparatus.

U.S. Pat. No. 6,214,421 granted to Pidzarko relies on the application of moisture to the substrate but this significantly increases the cost of the process. By adding moisture to the process, this will increase the process time and leads to potential degassing issues as the plastic substrates will absorb moisture below the surface and when cured, will cause severe surface blemishes. The invention of Pidzarko is intended for flat wood substrates.

### SUMMARY OF THE INVENTION

It is therefore an object of the present invention to provide a process which allows for the application of a decorative or functional coated service to a nylon substrate providing a first class surface finish in either high gloss, medium gloss, matte gloss, metallic or textured finishes in a wide variety of powder material colors.

A further object of this invention is to provide an apparatus for a process which provides a first class surface finish which is independent of external environmental factors such as dirt, humidity, temperature fluctuations so that a reproducible finish is achievable.

A still further object of this invention is to provide a process for the application of a powder to a non-conductive substrate such as nylon without the need for conductive primers, conductive impregnated substrates and the use of any electrostatic spray equipment thus reducing the costs and increasing the efficiencies of the process.

It is yet a further object of this invention is to provide a suitable painting process to eliminate or replace existing processes which use paints, primers and which emit VOC's.

A still further object of this invention is to provide a cost effective method of applying a decorative or functional painted surface to plastic or non-conductive substrates.

It is a further object of this invention to provide a process which has eliminated the need for use of conductive primers.

A still further object of this invention is to provide a process which has eliminated the need for any electrostatic spraying equipment thus significantly reducing costs and increasing safety of the method of powder coating applications.

A further object of this invention is to reduce the overall steps required to provide a first class finish to a non-conductive substrate.

It is a further object of this invention to reduce the length of curing ovens which typically are very long and expensive and which require a significant amount of energy.

It is still a object of this invention is to provide an inline, enclosed environmentally controlled apparatus which reduces or eliminates airborne contamination which is associated with traditional powder coating apparatus.

### SUMMARY OF THE INVENTION

The present invention relates to a process and an apparatus which increases the efficiency of the application of thermosetting powder coatings on non-conductive substrates.

The present invention provides an improved process and apparatus for increasing the efficiency and processing of the application of thermosetting powder coatings on plastic substrates such as nylon. It provides a multi-step process to ensure a highly reproducible finish meeting a minimum of first class surface finish standards which are acceptable within the automotive industry.

The process and apparatus allow for the coating of hanging substrates moving along a continuous overhead conveyor system which travels through a contained preparatory and paint booth system to ensure cleanliness, temperature control and humidity for the purposes of providing a highly reproducible environment.

The preferred embodiment couples the system with a continuous overhead conveyor system which may be an indexing type conveyor system. This allows the operator to probe and measure the surface temperature of the substrate at various intervals in the process.

The design of the system incorporates a cleaning booth which rinses the substrates and then blow dries the substrates with warm air. The substrates upon drying are spray coated with a water-based adhesive/primer whereby the adhesive/primer is cured in a convection oven at a temperature and for a time sufficient for the adhesive primer to cure. The purpose of the adhesive/primer is to allow the powder to bond properly during the powder curing stage and to protect the surface of the plastic substrate from any undue chemical reaction with the thermosetting powder.

The substrates are transported via the conveyor system through a control tunnel in which the parts are measured via a temperature probe which in turn controls a IR heating system which is sufficient to maintain the surface and core temperature of the substrates to a specified temperature.

The substrates are then powder coated by a non-electrostatic powder spray method at a sufficient volume and for a sufficient time to coat the substrates in accordance with the specified film desired.

Once the substrates are coated, they are then transferred to the curing oven via the overhead conveyor system. The curing oven employs both an IR heating system and a convection oven and the IR system brings the surface temperature of the part to a curing temperature immediately thus reducing the length of time necessary in the convection oven. This method provides the best curing for the part which aids in the reduction of the overall length of the curing oven and subsequently makes the process more efficient and less costly from a capital investment point of view.

The substrates leave the curing oven and move to a subsequent process stage in which the substrates move to a temperature and humidity control tunnel with an IR heating controlled by temperature probes measuring substrate surface temperatures or alternatively, the substrates will exit the process for unracking.

The substrates which proceed through the control tunnel will enter a subsequent powder coating station wherein a non-conductive application of powder will be layered onto the existing cured or semi cured base coat. The application will be for a sufficient time and volume to allow for the sufficient coating of the substrate.

Once the substrates have been coated, they are then transferred to the second curing oven via the overhead conveyor system. The curing oven uses both IR heating systems and convection oven heating systems. The IR system brings the surface temperature of the part to a curing temperature immediately thus reducing the length of time necessary in the convection oven. This provides a better curing for the part which aids in the overall reduction in the length of the cure oven making the process more efficient.

The substrates then leave the second curing oven via the overhead conveyor system to the unracking station.

### BRIEF DESCRIPTION OF THE DRAWINGS

FIG. 1 illustrates in schematic form a machine designed to carry out the process and the method of the present invention.

FIG. 2 illustrates a graph to indicate two alternative solutions for the curing of substrates within curing oven after being applied with a coating of thermosetting powder resins.

### DETAILED DESCRIPTION OF THE PREFERRED EMBODIMENT

The drawings show a process and apparatus for the application of thermosetting powders to non-conductive substrates by means of an inline coating system which controls the environment inside the apparatus to form ideal coating conditions while maintaining the substrate temperature at exacting levels necessary for the application of thermosetting powders. The substrates may be nylon, PCABS and ABS materials.

The apparatus and process allow for a single or multiple layer of thermosetting powders to be applied, producing various surface finishes including high gloss, gloss, matte, textured and metallic surface finishes.

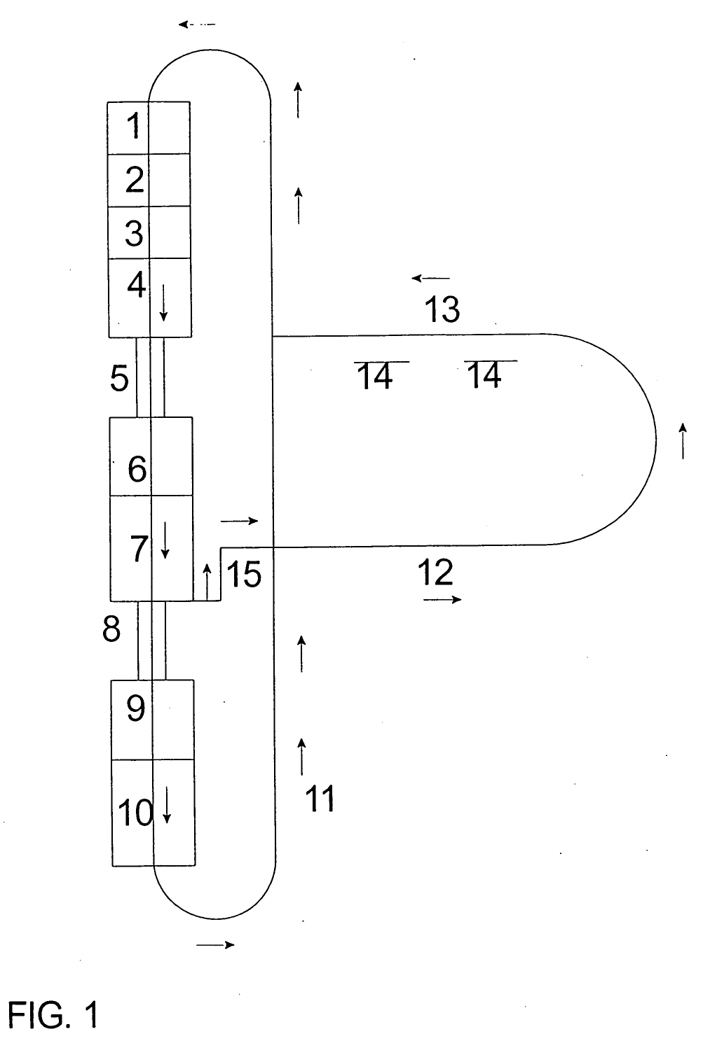

FIG. 1. shows in schematic form a machine designed to carry out the process or method of this invention.

The machine has a continuous conveyor 11 which has both an infeed or racking area 13 for the purposes of placing substrates on carriers 14 to be moved through the process via the conveyor 11.

There is an outfeed or un-racking area 12 designed for the purposes of removing the completed substrates from the carriers to prepare for the next batch of substrates to be racked in area 13.

The process is a continuous conveyor system 11 where the substrates enter a spray wash and rinse booth 1 where the substrates are washed and rinsed with water. The substrates then travel via the continuous conveyor 11 to the next station 2 where the substrates are dried to remove any excess rinse materials via a warm air blower system.

The substrates travel via the continuous conveyer 11 to the next station 3 where the substrates will receive an application of a waterbased adhesive/protectant solution via aerosol spray guns. This water-based adhesive/protectant will allow for the necessary adhesion of the painted surface and protect the substrate from unwanted chemical reactions from subsequent processing. The substrates once having the adhesive/protectant layer applied will immediately move via the continuous conveyor 11 to a drying oven 4 in which the substrates will receive convection or IR heating at a temperature of 325 degrees Farenheit for a period of not more than 10 minutes. Upon exiting the station 3, the substrates move via the overhead continuous conveyor 11 into a temperature control tunnel 5 with the temperature controlled by IR devices. The IR devices in tunnel 5 will maintain the substrate temperature necessary for the proper subsequent application of further processes.

The temperature control of tunnel 5 is controlled via an automatic passive temperature probe which monitors the surface temperature of the substrate parts at desired intervals. The temperature of tunnel 5 maintains the substrate surface temperature of between 265 degrees Farenheit and 290 degrees Farenheit prior to exiting tunnel 5.

The substrates move via the continuous overhead conveyer 11 and enter station 6 for the purposes of powder coating application. The substrates in station 6 are sprayed with one or more non electrostatic powder coating by a paint gun or paint guns in an automatic fashion. The application of the powder occurs while the surface temperature of the part is below the curing temperature of the powder and at a temperature between 265 degrees Farenheit and 290 degrees Farenheit.

Once the substrates have been powder coated, they travel via the continuous overhead conveyor system 11 to station 7 which is a curing oven employing a mixture of IR units to bring the surface temperature of the part immediately to the curing temperature of between 325 degrees Farenheit and 375 degrees Farenheit and where the convection oven will maintain the surface and core temperature of the part for a period of between 3 minutes and 7 minutes.

The substrates travelling via the overhead continuous conveyor 11 then exit the coating system via off-feed conveyor system 15 in which case the substrates will move to un-racking area 12 or continue to tunnel 8 for further processing.

Further processing will entail the application of an additional powder coat, which is usually a clear coat or top sealer. The substrates travelling via the overhead continuous conveyor move to tunnel 8 where the parts enter a temperature control tunnel with the temperature controlled by IR devices.

The IR devices in tunnel 8 maintain the substrate temperature necessary for the proper subsequent application of further processes. The temperature control of tunnel 8 is controlled via an automatic passive temperature probe which monitors the surface temperature of the substrate parts at desired time intervals. The temperature of tunnel 8 maintains the substrate surface temperature of between 265 degrees Farenheit and 290 degrees Farenheit prior to exiting tunnel 8. The substrates moving via the continuous overhead conveyer enter station 9 for the purposes of powder coating application in which the parts in station 9 are sprayed with one or more non electrostatic powder coating paint gun or guns in an automatic fashion.

The application of the powder occurs while the surface temperature of the part is below the curing temperature of the powder and at a temperature between 265 degrees Farenheit and 290 degrees Farenheit. Once the substrates have been powder coated, they travel via the continuous overhead conveyor system 11 to station 10, which is a curing oven employing a mixture of IR units which bring the surface temperature of the part to the curing temperature of between 325 degrees Farenheit and 375 degrees Farenheit and where the convection oven maintains the surface and core temperature of the part for a period of between 3 minutes and 7 minutes. Once the part is cured in station 10, the parts travel via the overhead conveyor system 11 to un-racking area 12 where the carriers 14 are unloaded.

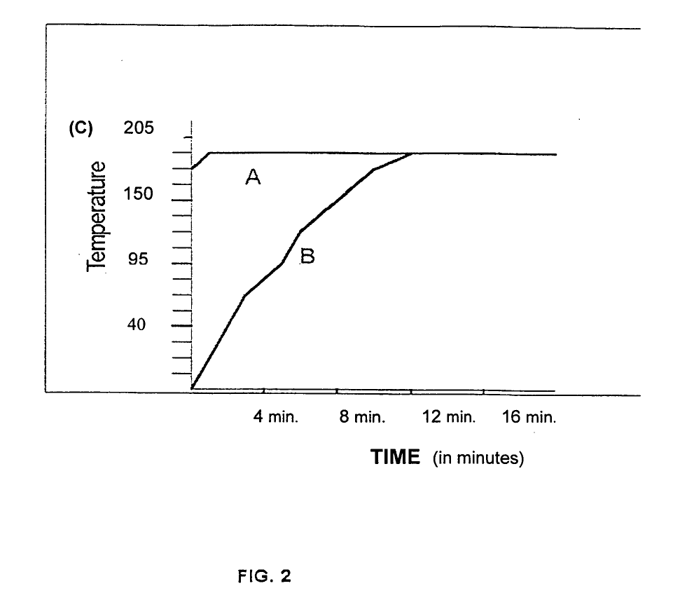

FIG. 2 illustrates a graph indicating two alternative solutions for the curing of substrates within a curing oven after being applied with a coating of thermosetting powder coatings. A thermosetting powder requires the curing via heat. Different powders are designed to set at different temperatures. For the purposes of this illustration, the curing temperature is set at 375 degrees Farenheit.

In FIG. 2, graph B indicates the time required using traditional convection oven technology art for the purposes to achieve a temperature of 375 degrees Farenheit for the part. The time for the surface temperature of the substrate to achieve the temperature in graph B is 12 minutes. The curing of the thermosetting powder does not occur during this 12-minute period and thus it would be beneficial to derive an alternate method to reach the prescribed surface temperature as quickly as possible prior to or upon entering the curing oven.

Graph A illustrates the method for achieving an immediate surface temperature via an IR unit placed within or just prior to the convection oven. The substrates travel on an the overhead conveyor pass between two IR units with temperature probes to monitor the surface temperature of the substrate. This ensures that the proper curing temperature is met and this immediately begins the curing process. Once the substrates have reached the prescribed curing temperature, the substrates enter the convection oven via the overhead conveyor system for a period and at a temperature necessary to cure the thermosetting powder completely.

The combination of both IR and convection ovens has produced ideal coated substrates. The convection oven provides a core temperature necessary to bind the thermosetting powder to the substrate while the initial IR heating brings the surface temperature immediately to curing temperature thus reducing the overall curing time compared to the prior art.

This invention and method allows for substantial reduction in the convection oven length resulting in savings of energy and smaller space requirements for the process as compared to the prior art. Overhead conveyors typically travel at between 15 and 19 feet per minute. The reduction in process time can be equated directly to the length of the system and equates to decrease of 12 minutes in the process for a mono coated substrate and a decrease of 24 minutes in the process for a double-coated substrate.

The actual design of the apparatus as described will decrease in length between 180 feet and 228 feet for a mono coat system and 360 feet and 556 feet for a double coated system over that of the prior art.

The present invention may be used with a nylon substrate or any suitable plastic or non-conductive substrate. Examples of such substrates include ABS resins such as those commercially available from The Dow Chemical Company under the trade name MAGNUS 1040, MAGNUM 1150EM, MAGNUM 3404 and MAGNUS 344 H.P.

The processing temperature for these materials varies and is within the knowledge of the skilled chemist and is generally published by the manufacturer of these resins. The temperature must be lower than the VICAT melting point of the material.

For example, if the VICAT is 240° Farenheit, the primer cure would take place at about 200° Farenheit, the powder coat would be applied at less than 200° Farenheit and the powder would be cured at about 200° Farenheit.

The present process is applicable for all types of plastics. The only restriction on the process is the ability to attain a sufficient VICAT temperature.

In summary, the present method allows for a smaller apparatus, more efficiency and reduces energy consumption and provides a superior thermosetting powder coated substrate over the prior art.

While the present invention describes and discloses the preferred embodiment, it is understood that the present invention is not so restricted.

1. A method for powder coating a non-conductive plastic substrate comprising the following steps:
(a) cleaning said substrates to remove any contaminants or mold release agents therefrom;
(b) applying an adhesive/sealer to said substrate;
(c) curing said adhesive/sealer by means of heat;
(d) applying a thermosetting powder to the hot substrate; and
(e) curing said thermosetting powder with heat.

2. A process as claimed in claim 1 further including applying an additional layer of thermosetting powder to the substrate while said substrate is still hot.

3. A process as claimed in claim 2 further including the additional step of curing said additional layer of thermosetting powder with heat.

4. A process as claimed in claim 1 wherein said non-conductive plastic substrate is polyamide.

5. A process as claimed in claim 1 wherein said substrate is moved through the sequence series of steps by the use of a continuous overhead conveyor.

6. A process as claimed in claim 1 wherein said substrate is cleaned in a cleaning booth which spray rinses said substrates and then blow dries said substrates with warm air.

7. A process as claimed in claim 1 wherein said adhesive/sealer is spray coated to said substrate.

8. A process as claimed in claim 1 wherein said adhesive/sealer is cured in a convection oven at a temperature and for a time sufficient for the adhesive/primer to cure.

9. A process as claimed in claim 1 wherein said substrate is moved from step (c) to step (d) through a controlled tunnel in which the surface and core temperature of said substrate is measured via a temperature probe which controls an infrared heating system which maintains the surface and core temperature of the substrates at a specified temperature.

10. A process as claimed in claim 1 wherein said thermosetting powder is applied to said substrate through a non-electrostatic powder spray at a sufficient volume and for a sufficient time to coat said substrate in accordance with the specified film desired.

11. A process as claimed in claim 1 wherein said thermosetting powder is cured in a curing oven employing an infrared heating system and a convection oven heating system.

12. A process as claimed in claim 11 wherein said infrared heating system brings the surface temperature of the substrate to be cured to the curing temperature quickly.

13. A process as claimed in claim 2 wherein said substrate is moved from the step curing the thermosetting powder to the step of applying an additional layer of thermosetting powder through a temperature and humidity controlled tunnel with IR heating controlled by temperature probes measuring substrate surface temperatures.

14. A process as claimed in claim 1 wherein said additional layer of thermosetting powder is applied to the substrate for a sufficient time and volume to allow for the sufficient coating of the substrate as desired.

15. A process as claimed in claim 14 wherein said subsequent powder coating is cured in a second curing oven using an IR heating system and a convection over heating system wherein said IR system brings the surface temperature of the part to the curing temperature quickly.

16. A process as claimed in claim 15 wherein said substrate is un-racked subsequent to the second curing oven.

17. A process as claimed in claim 7 wherein said adhesive/sealer is water based.

18. A process a claimed in claim 8 wherein said curing takes place at a temperature of 165 degrees Centigrade (325° Fahrenheit) for a period of not more than 10 minutes.

19. A process as claimed in claim 9 wherein said surface temperature of the substrate is maintained between 130 degrees Centigrade (265° Fahrenheit) and 145 degrees Centigrade (290° Fahrenheit).

20. A process as claimed in claim 11 wherein said curing takes place at a temperature between 165 degrees Centigrade (325° Fahrenheit) and 190 degrees Centigrade (375° Fahrenheit).

21. A process as claimed in claim 12 wherein said curing temperature is between 165 degrees Centigrade (325° Fahrenheit) and 190 degrees Centigrade (375° Fahrenheit).

22. A process as claimed in claim 12 wherein said curing time takes between 3 and 7 minutes.

23. A process as claimed in claim 14 wherein said additional layer is a powder coat which is a clear coat or a top sealer.

24. A process as claimed in claim 1 wherein said curing takes place at a temperature lower than the VICAT melting point of said adhesive/sealer and powder.

25. A process as claimed in claim 24 wherein said curing temperature is between 65 degrees Centigrade (150° Fahrenheit) and 190 degrees Centigrade (375° Fahrenheit).

26. A process as claimed in claim 25 wherein said curing takes place at 95 degrees Centigrade (200° Fahrenheit).
